(19) United States
(12) Patent Application Publication
(10) Pub. No.: US 2026/0042650 A1
(43) Pub. Date: Feb. 12, 2026

(54) Top Module for a Mobile Robot

(71) Applicant: Nord Modules A/S, Odense S (DK)

(72) Inventor: Kristian Kvistgaard, Ringe (DK)

(21) Appl. No.: 19/361,302

(22) Filed: Oct. 17, 2025

Related U.S. Application Data
(63) Continuation of application No. PCT/DK2024/050060, filed on Mar. 22, 2024.

(30) Foreign Application Priority Data
Apr. 21, 2023 (DK) PA 2023 00341

(51) Int. Cl. B66F 9/12; B66F 7/06; B66F 9/065

(52) U.S. Cl. CPC B66F 9/12; B66F 7/065; B66F 9/065

(57) ABSTRACT

A top module configured to be placed on a mobile robot and be mechanically and electrically connected to the mobile robot is disclosed. The top module comprises a base member resting on the mobile robot, a top plate for receiving one or more objects, and at least one lifting mechanism to elevate the top plate relative to the base member. The lifting mechanism has two arms rotatably attached to one another. One arm is attached to the top plate. The other arm is attached to the base member. An actuator is arranged and configured to provide a force, having a force component extending in a direction parallel to the bottom plate, on a push member having a contact structure bearing against one of the arms.

### CROSS-REFERENCE TO RELATED APPLICATIONS

This application is a continuation under 35 U.S.C. 111 of International Patent Application No. PCT/DK2024/050060, filed Mar. 22, 2024, which claims the benefit of and priority to Danish Application No. PA 2023 00341, filed Apr. 21, 2023, each of which is hereby incorporated by reference in its entirety.

### FIELD OF INVENTION

The present invention relates to a top module for a mobile robot, wherein the top module comprises a lifting device.

### BACKGROUND

Top modules are designed for being used together with mobile robots in order to increase the areas of use. Some top modules are referred to as lift modules. This kind of module is constructed to elevate objects resting on the top plate of the top module.

Different kinds of lifting mechanisms are known in the prior art.

US 2011238205 A discloses a robot for moving an object without applying compression forces to the object. The robot comprises a receiving surface for receiving and holding an object, a movement mechanism for moving the receiving surface in a desired direction, a sweeping mechanism pivotably connected to the receiving surface for sweeping at least a portion of the object onto the receiving surface, and a mobile platform for moving the robot along a surface. The robot comprises scissor arms moveably arranged by using an actuator (a piston). This lifting mechanism, however, requires an actuator that can provide a very large force.

KR 102274498 B1 discloses an omnidirectional transport robot equipped with a lift. The robot comprises a transfer unit which can be transferred in a set direction as a plurality of mecanum wheels are formed on the front and rear wheels on a transfer frame for installing various members. The robot comprises an elevating unit formed on the upper part of the transfer unit and supported by the transfer frame to raise and lower the upper part to adjust a height and a support unit formed on the upper part of the elevating unit and formed to be able to load various objects on the upper surface. The elevating unit is, however, very large and a large force is required to carry out lifting tasks.

Accordingly, it would be an advantage to have a lifting mechanism in which the force provided by the actuator is smaller.

Thus, there is a need for a top module which reduces or even eliminates the above-mentioned disadvantages of the prior art.

### SUMMARY

A top module according to the present disclosure is a top module configured to be placed on the top of a mobile robot and be mechanically and electrically connected to the mobile robot, wherein the top module comprises:
a base member configured to be arranged on and hereby rest on the mobile robot;
a top plate configured to receive one or more objects;
at least one lifting mechanism arranged and configured to elevate the top plate relative to the base member,
   wherein the lifting mechanism comprises:
   a) a first arm rotatably attached to an attachment structure that is attached to or integrated into the base member, wherein the first arm in its distal end comprises a contact member;
   b) a second arm rotatably attached to an attachment structure that is attached to or integrated into the top plate;
   c) an actuator arranged and configured to provide a force (Fₕ) having a force component extending in a direction parallel to the bottom plate, wherein the second arm in its distal end is rotatably attached to a central portion of the first arm,
   wherein the lifting mechanism comprises a push member provided with a contact structure in it its distal end, wherein the push member is connected to or integrated into the actuator, wherein the contact structure is arranged and configured to bear against a contact portion of the first arm.

Hereby, the force (Fₕ) provided by the actuator is transferred to the first arm in such a manner that the contact member provides a lifting force (Fᵥ) of basically the same size as the force (Fₕ) provided by the actuator. Accordingly, it is possible to provide a lifting mechanism in which the force provided by the actuator is smaller.

The top module according to the present disclosure is a top module configured to be placed on the top of a mobile robot and be mechanically and electrically connected to the mobile robot. The mobile robot may be an automatic guided vehicle (AGV), e.g. an unmanned guided vehicle that moves throughout a facility by following a set of predetermined paths. The mobile robot may be an autonomous mobile robot (AMR) that is enabled to collaborate in material handling tasks with humans.

The top module comprises a base member configured to be arranged on and hereby rest on the mobile robot. The base member may be a plate.

In an embodiment, the base member is formed as a grate. In an embodiment, the base member comprises parallel bars.

The top module comprises a top plate configured to receive one or more objects. The top module may be a plate. In an embodiment, the top module is formed as a grate. In an embodiment, the top module comprises parallel bars.

The top module comprises at least one lifting mechanism arranged and configured to elevate the top plate relative to the base member.

The lifting mechanism comprises a first arm rotatably attached to an attachment structure that is attached to or integrated into the base member, wherein the first arm in its distal end comprises a contact member.

The lifting mechanism comprises a second arm rotatably attached to an attachment structure that is attached to or integrated into the top plate.

The lifting mechanism comprises an actuator arranged and configured to provide a force (Fₕ) having a force component extending in a direction parallel to the bottom plate.

The second arm in its distal end is rotatably attached to a central portion of the first arm. In an embodiment, the second arm is rotatably attached to a central portion of the first arm by using a pivot joint.

The lifting mechanism comprises a push member provided with a contact structure in it its distal end, wherein the push member is connected to or integrated into the actuator, wherein the contact structure is arranged and configured to bear against a contact portion of the first arm. In an embodiment, the push member is formed as a rod.

The term “central portion” means a portion between the proximal and distal part.

In an embodiment, the second arm in its distal end is rotatably attached to a central portion of the first arm (by using a pivot joint).

In an embodiment, the contact portion of the first arm comprises a convex part provided in the distal end of the first arm.

In an embodiment, the contact portion of the first arm comprises a concave part extending in extension of the convex part.

In an embodiment, the concave part is provided more proximally than the convex part.

In an embodiment, the contact member is rotatably attached to the distal portion of the first arm by using a joint comprising a shaft.

In an embodiment, the contact member is cylindrical and configured to rotate like a wheel when the first arm is rotated about the joint.

In an embodiment, the contact structure is rotatably attached to the distal portion of the push member, wherein the contact structure is configured to rotate and be moved along the contact portion of the first arm when the push member is moved.

In an embodiment, the contact structure rests on a slider.

In an embodiment, the slider is slidably mounted in a guide member.

In an embodiment, the guide member is formed as a track having a uniform cross-sectional area.

In an embodiment, the guide member is formed as a track having a profile that fits the inner profile of the slider in such a manner that the center of mass of the guide member can only be moved along a single line. Hereby, the push member is supported by the slider and the motion of the slider can be fully controlled by using simple elements.

In an embodiment, the lifting mechanism is formed as an elongated member comprising two lifting members provided in each end of the elongated member.

In an embodiment, the two lifting members are identical.

In an embodiment, the lifting mechanism comprises a first connection structure and a second connection structure extending parallel to each other, wherein the actuator is arranged between the connection structures.

In an embodiment, the lifting mechanism comprises two lifting members, wherein the first connection structure is arranged and configured to synchronize the motion of the two lifting members.

In an embodiment, the lifting mechanism comprises two lifting members, wherein a first connection structure and a second connection structure are arranged and configured to synchronize the motion of the two lifting members.

In an embodiment, the second connection structure is provided with:

a) a first slot provided in the first end of the second connection structure; and
b) a second slot provided in the opposite end of the second connection structure.

In an embodiment, the first arm comprises a first portion and a second portion extending parallel to the first portion, wherein the first portion and a second portion are separated from each other, wherein the second arm is sandwiched between the first portion and a second portion.

In an embodiment, the convex contact portion has a semi-circular cross section.

In an embodiment, the concave contact portion has a semi-circular cross section.

In an embodiment, the semi-circular cross section of the convex contact portion is of a larger diameter than the semi-circular cross section of the concave contact portion.

In an embodiment, the proximal part of the contact portion of the first arm is straight.

In an embodiment, the thickness of the actuator corresponds to or is smaller than the distance between the top plate and the bottom plate.

In an embodiment, the actuator is an electrical actuator. In an embodiment, the actuator is a linear actuator (an actuator that converts rotational motion in a motor into linear or straight push/pull movement).

In an embodiment, the second arm is rotatably attached to a central portion of the first arm by a joint.

In an embodiment, the second arm is, in its lower end, rotatably attached to a central portion of the first arm by a joint.

In an embodiment, the second arm is in its upper end rotatably attached to the attachment structure by a joint.

In an embodiment, the contact member is rotatably attached to the first arm.

### BRIEF DESCRIPTION OF THE DRAWINGS

The devices and methods will become more fully understood from the detailed description given herein below. The accompanying drawings are given by way of illustration only. In the accompanying drawings:

FIG. 1A shows a cross-sectional view of a portion of a top module according to an embodiment;

FIG. 1B shows a perspective side view of a lifting mechanism of a top module according to an embodiment;

FIG. 1C shows a perspective end view of the lifting mechanism shown in FIG. 1B;

FIG. 2A shows a perspective side view of the lifting mechanism shown in FIG. 1B and FIG. 1C;

FIG. 2B shows a side view of the lifting mechanism shown in FIG. 2A;

FIG. 2C shows a top view of the lifting mechanism shown in FIG. 2A and FIG. 2B;

FIG. 3A shows a top module according to an embodiment being used together with a mobile robot;

FIG. 3B shows a top module according to an embodiment before it is connected to a mobile robot;

FIG. 3C shows the top module shown in FIG. 3B in a configuration in which the top module has been connected to the mobile robot;

FIG. 4A shows a perspective side view of the lifting member corresponding to the one shown in FIG. 1A;

FIG. 4B shows another perspective side view of the lifting member shown in FIG. 4A;

FIG. 5A shows a lifting device according to an embodiment; and

FIG. 5B shows the lifting mechanism shown in FIG. 1B seen from the opposite side.

### DETAILED DESCRIPTION

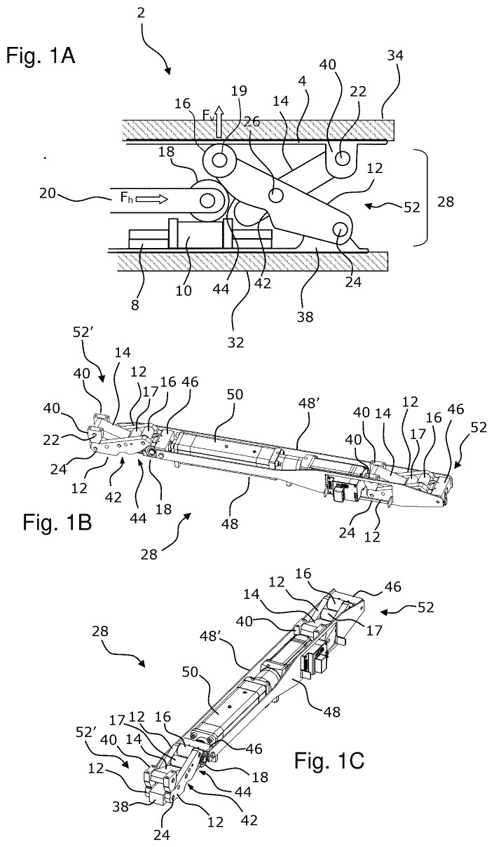

Referring now in detail to the drawings for the purpose of illustrating embodiments of the present devices and methods, a top module 2 is illustrated in FIG. 1A.

FIG. 1A is a cross-sectional view of a portion of a top module 2 according to an embodiment. The top module 2 comprises a base member 32, a support member 34 and a lifting mechanism 28 arranged therebetween. The lifting mechanism 28 comprises a lifting member 52.

The base member 32 is typically plate shaped. The base member 32 can, however, be formed as a grate or parallel bars.

The support member 34 is typically plate shaped. The support member 34 can, however, be formed as a grate or have another geometry if desired.

The lifting mechanism 28 comprises a top plate 4 and a bottom plate 6. The lifting mechanism 28 comprises a first arm 12 that is rotatably attached to an attachment structure 38 that is attached to the bottom plate 6. The first arm 12 is in its lower end rotatably attached to the attachment structure 38 by a joint 24.

The lifting mechanism 28 comprises a second arm 14 that is rotatably attached to an attachment structure 40 attached to the top plate 4. The second arm 14 is in its upper end rotatably attached to the attachment structure 40 by a joint 22.

The second arm 14 is in its lower end rotatably attached to a central portion of the first arm 12 by a joint 26. A contact member 16 is provided in the distal (and upper) end of the first arm 12. The contact member 16 is rotatably attached to the first arm 12 by a joint comprising a shaft 19. In an embodiment, the contact member 16 is cylindrical and configured to rotate like a wheel when the first arm 12 is rotated about the joint 24. Accordingly, by rotating the first arm 12 about the joint 24, it is possible to lower or elevate the top plate relative to the bottom plate 6.

The lifting mechanism 28 comprises a push member 20 provided with a contact structure 18 at its distal end. The contact structure 18 is arranged and configured to bear against the arm 12 and hereby rotate the arm 12 about the joint 24. Accordingly, by providing a horizontally directed force Fₕ as indicated in FIG. 1A, it is possible to rotate the first arm 12 clockwise and hereby elevate the top plate 4 relative to the bottom plate 6 because the second arm 14 provides a vertical force Fᵥ towards the top plate 4.

The horizontally directed force Fₕ provided by the push member 20 is generated by an actuator (see FIG. 1B). In an embodiment, the push member 20 is integrated in and therefore constitutes a distal end of the actuator.

The fist arm 12 comprises a contact portion having a distal convex part 44 and a central concave part 42.

The contact structure 18 of the push member 20 rests on a slider 10 that is slidably attached to a guide member 8. In an embodiment, the guide member 8 is formed as a track having a profile that fits the inner profile of the slider 10 in such a manner that the center of mass of the guide member 8 can only be moved along a single line. Hereby, the push member 20 is supported by the slider 10 and the motion of the slider 10 can be fully controlled using simple elements.

FIG. 1B illustrates a perspective side view of a lifting mechanism 28 of a top module according to an embodiment. The lifting mechanism 28 is formed as an elongated member comprising two lifting members 52, 52′ provided in each end of the elongated member. Each lifting member 52, 52′ basically corresponds to the one shown in and explained with reference to FIG. 1A. Each lifting member 52, 52′ comprises a first arm 12 that is rotatably attached to an attachment structure 38 that is configured to be attached to a bottom plate like shown in and explained with reference to FIG. 1A. The first arm 12 is in its lower end rotatably attached to the attachment structure 38 by a joint 24.

Each lifting member 52, 52′ comprises a second arm 14 that is rotatably attached to an attachment structure 40 configured to be attached to a top plate such as the one shown in and explained with reference to FIG. 1A. The second arm 14 is in its upper end rotatably attached to the attachment structure 40 by a joint 22.

The second arm 14 is in its lower end rotatably attached to a central portion of the first arm 12 by a joint. A contact member 16 is provided in the distal (and upper) end of the first arm 12. The contact member 16 is rotatably attached to the first arm 12 by a joint comprising a joint structure 17.

The contact member 16 is cylindrical and configured to rotate like a wheel when the first arm 12 is rotated about the joint 24.

Each lifting member 52, 52′ is controlled by the same actuator 50 provided between the lifting member 52, 52′. The actuator 50 is arranged to move the push structure 46 of the lifting member 52′ towards the distal portion of the lifting member 52′. Hereby, the actuator 50 can initiate a rotation of the first arm 12

A first connection structure 48 connects the push structure 46 of the lifting member 52′ and the push structure 46 of the other lifting member 52. Accordingly, when the actuator 50 moves the push structures 46 of the lifting member 52′, the first connection structure 48 will pull the push structures 46 of the lifting member 52.

Accordingly, the lifting members 52, 52′ are driven synchronously by a single actuator 50 only.

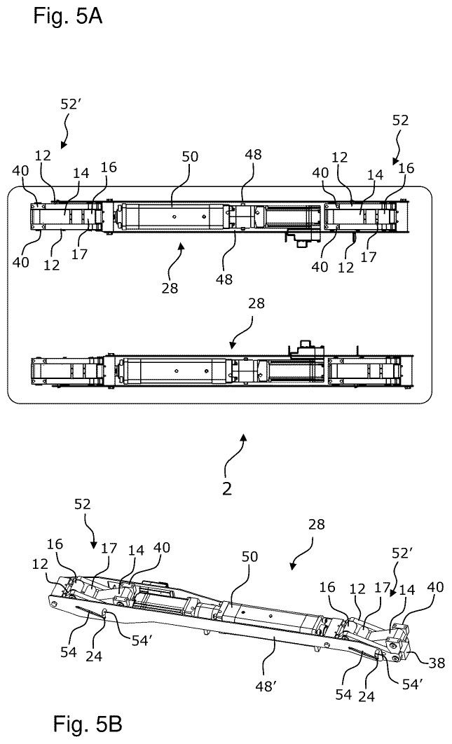

The lifting mechanism 28 comprises a second connection structure 48′ (shown and explained with reference to FIG. 5B).

The fist arm 12 comprises a contact portion (a lower surface) having a distal convex part 44 and a central concave part 42. The contact portion of the fist arm 12 is in contact with a contact structure 18 that is connected to a slidably arranged portion of the actuator 50 extending between the lifting member 52, 52′.

FIG. 1C illustrates a perspective end view of the lifting mechanism 28 shown in FIG. 1B.

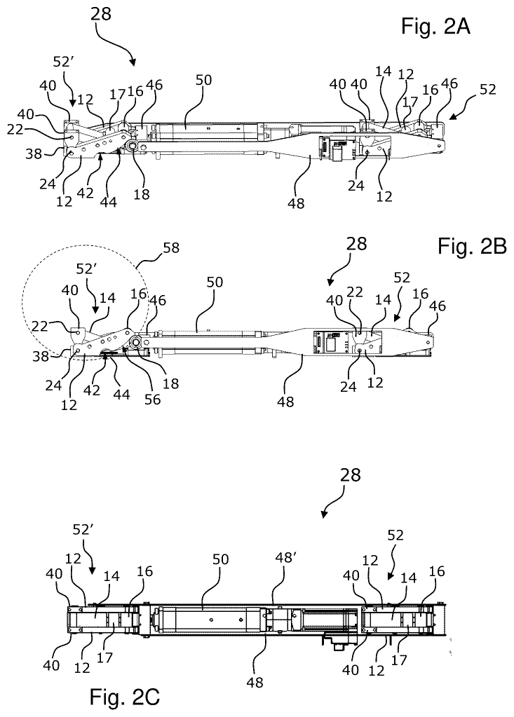

FIG. 2A illustrates a perspective side view of the lifting mechanism 28 shown in FIG. 1B and FIG. 1C.

FIG. 2B illustrates a side view of the lifting mechanism 28 shown in FIG. 2A. It can be seen that the convex contact portion 44 has a semi-circular cross section as indicated by a dotted circle 58. Likewise, it can be seen that the concave contact portion 42 has a semi-circular cross section as indicated by a dotted circle 56 that is smaller than the dotted circle 58.

FIG. 2C illustrates a top view of the lifting mechanism 28 shown in FIG. 2A and FIG. 2B.

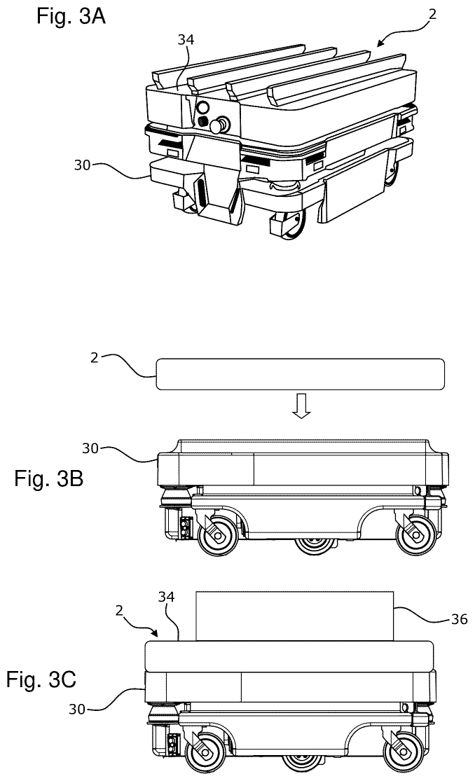

FIG. 3A illustrates a top module 2 according to an embodiment being used together with a mobile robot 30. The top module 2 is configured to be placed on the mobile robot 30 and be mechanically and electrically connected to the mobile robot 30. Accordingly, the control unit of the mobile robot 30 may be used to control the actuator(s) of the top module 2 in order to elevate or lower the support member 34 of the top module 2.

FIG. 3B illustrates a top module 2 according to an embodiment before it is connected to a mobile robot 30.

FIG. 3C illustrates the top module 2 shown in FIG. 3B in a configuration in which top module 2 has been connected to the mobile robot 30. An object 36 is placed on the support member 34 of the top module 2.

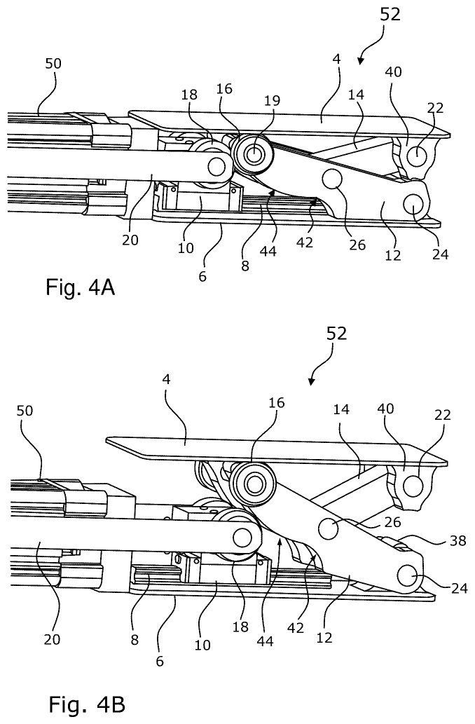

FIG. 4A illustrates a perspective side view of the lifting member 52 corresponding to the one shown in and explained with reference to FIG. 1A. It can be seen that the lifting member 52 is in its lowest configuration in which the lower side of the proximal portion of the first arm 12 bears against the bottom plate 6.

FIG. 4B illustrates another perspective side view of the lifting member 52 shown in and explained with reference to FIG. 4B. The lifting member 52 is in a higher configuration in which the lower side of the proximal portion of the first arm 12 no longer bears against the bottom plate 6. The push member 20 may still be moved further to the right to rotate the first arm 12 about its joint 24.

FIG. 5A illustrates a lifting device 2 according to an embodiment. The support member constituting the uppermost structure of the lifting device 2 has been removed in order to see the lifting mechanisms 28 of the lifting device 2. The lifting device 2 comprises two lifting mechanisms 28 extending parallel to each other.

Depending on the dimensions and lifting demand of the lifting device 2, the number of lifting mechanisms 28 may differ. In an embodiment, the lifting device 2 comprises three lifting mechanisms 28.

FIG. 5B illustrates the lifting mechanism 28 shown in FIG. 1B seen from the opposite side. The lifting mechanism 28 is formed as an elongated member comprising two lifting members 52, 52′ provided in each end of the elongated member.

The lifting mechanism 28 comprises a connection structure 48′. In each end of the connection structure 48′ a first slot 54 and a second slot 54′ is provided. The slots 54, 54′ are designed to guide the two lifting members 52, 52′ and make them move synchronously. Accordingly, when the first lifting member 52 is activated by the actuator, the second lifting member 52′ is activated in a similar manner.

### LIST OF REFERENCE NUMERALS

2 Lifting device
4 Top plate
6 Bottom plate
8 Guide member
10 Slider
12 First arm
14 Second arm
16 Contact member (e.g. a rotatably mounted wheel)
17 Joint structure
18 Contact structure
19 Shaft
20 Push member (connected to or integrated into an actuator)
22 Joint
24 Joint
26 Joint
28 Lifting mechanism
30 Mobile robot
32 Base member
34 Support member
36 Object
38 Attachment structure
40 Attachment structure
42 Concave part
44 Convex part
46 Push structure
48, 48′ Connection structure
50 Actuator
52, 52′ Lifting member
54, 54′ Slot
56 Circle
58 Circle
Fₕ Horizontally directed force
Fᵥ Vertical force

What is claimed is:

1. A top module configured to be placed on a top of a mobile robot and be mechanically and electrically connected to the mobile robot, the top module comprising:
a base member configured to be arranged on and rest on the mobile robot;
a top plate configured to receive one or more objects; and
at least one lifting mechanism arranged and configured to elevate the top plate relative to the base member, wherein the lifting mechanism comprises:
a) a first arm rotatably attached to a first attachment structure that is attached to or integrated into the base member, wherein the first arm, in its distal end, comprises a contact member;
b) a second arm rotatably attached to a second attachment structure that is attached to or integrated into the top plate; and
c) an actuator arranged and configured to provide a force (Fₕ) having a force component extending in a direction parallel to the bottom plate,
wherein the second arm, in its distal end, is rotatably attached to a central portion of the first arm, wherein the lifting mechanism comprises a push member provided with a contact structure in it its distal end, wherein the push member is connected to or integrated into the actuator, wherein the contact structure is arranged and configured to bear against a contact portion of the first arm.

2. The top module according to claim 1, wherein the contact portion of the first arm comprises a convex part provided in the distal end of the first arm.

3. The top module according to claim 2, wherein the contact portion of the first arm comprises a concave part extending from the convex part.

4. The top module according to claim 1, wherein the contact member is rotatably attached to a distal portion of the first arm by a joint comprising a shaft.

5. The top module according to claim 1, wherein the contact structure is rotatably attached to a distal portion of the push member, wherein the contact structure is configured to rotate and be moved along the contact portion of the first arm when the push member is moved.

6. The top module according to claim 1, wherein the contact structure rests on a slider.

7. The top module according to claim 6, wherein the slider is slidably mounted in a guide member.

8. The top module according to claim 1, wherein the lifting mechanism is formed as an elongated member comprising two lifting members provided at each end of the elongated member.

9. The top module according to claim 8, wherein the two lifting members are identical.

10. The top module according to claim 8, wherein the lifting mechanism comprises a first connection structure and a second connection structure extending parallel to each other, wherein the actuator is arranged between the connection structures.

11. The top module according to claim 10, wherein the second connection structure is provided with:
a) a first slot provided in a first end of the second connection structure; and
b) a second slot provided in an opposite end of the second connection structure.

12. The top module according to claim 1, wherein the first arm comprises a first portion and a second portion extending parallel to the first portion, wherein the first portion and the second portion are separated from each other, wherein the second arm is sandwiched between the first portion and the second portion.

13. The top module according to claim 2, wherein the convex part has a semi-circular cross section.

14. The top module according to claim 3, wherein the concave part has a semi-circular cross section.

15. The top module according to claim 1, wherein a proximal part of the contact portion of the first arm is straight.

16. The top module according to claim 1, wherein a thickness of the actuator corresponds to or is smaller than a distance between the top plate and the bottom plate.
